(19) United States
(12) Patent Application Publication
(10) Pub. No.: US 2005/0208903 A1
(43) Pub. Date: Sep. 22, 2005

(54) Mobile phone and vibration control method of mobile phone

(75) Inventor: Masashi Sakamoto, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/898,990

(22) Filed: Jul. 27, 2004

(30) Foreign Application Priority Data
Mar. 17, 2004 (JP) 2004-076180

(51) Int. Cl. H04M 1/00

(52) U.S. Cl. 455/90.3; 455/567; 455/412.2

(57) ABSTRACT

Pressure applied to a mobile phone main body is detected at the time of call/mail arrival, and in compliance therewith vibration of a vibrator of a mobile phone is controlled. As a result, vibration is controlled in compliance with a degree of contact between the mobile phone and a body of a user, so that notification of an incoming call/mail by vibration can be conducted more surely.

### CROSS-REFERENCE TO THE INVENTION

This application is based upon and claims the benefit of priority from the prior Japanese Patent Application No. 2004-076180, filed on Mar. 17, 2004; the entire contents of which are incorporated herein by reference.

### BACKGROUND OF THE INVENTION

1. Field of the Invention

The present invention relates to a mobile phone (for example, cellular phone) having a vibrator which vibrates at the time of call/mail arrival and a method of vibration control for a mobile phone.

2. Description of the Related Art

A mobile phone can notify an incoming call/mail with vibration. More specifically, at the time of call/mail arrival the mobile phone vibrates to notify the arrival.

Incidentally, in relation to a folding portable communication device, an art is disclosed in which an open/close state of two-unit type communication device main bodies which are openable/closable is detected and then switching between a vibration mode and an incoming call/mail sound mode is conducted (See Japanese Patent Application Laid-open No. 2001-352369).

### SUMMARY OF THE INVENTION

An openable/closable mobile phone such as foldable type and the like is often used in such way as to be carried in a breast pocket of a user

In this case, if the mobile phone is in the breast pocket of the user without contacting a body, vibration of the mobile phone may not adequately transmit to the user who then may fail to notice call/mail arrival.

In view of the above, it is an object of the present invention to control vibration of the mobile phone so as to provide a mobile phone which is capable of notifying the user of the incoming call/mail more surely.

A. A mobile phone related to the present invention is constituted with a mobile phone main body, a vibrator vibrating the mobile phone main body, a pressure sensor detecting pressure applied to the mobile phone, and a vibration control unit controlling the vibrator in compliance with pressure detected by the pressure sensor at the time of call/mail arrival.

Pressure applied to the mobile phone main body is detected at the time of call/mail arrival, and then in compliance with this pressure vibration of the vibrator of the mobile phone is controlled. Consequently, in compliance with a degree of contact between the mobile phone main body and the body of the user vibration is controlled, so that notification of an incoming call/mail by vibration is conducted more surely.

(1) The mobile phone can further have a cover which is openable/closable to the mobile phone main body, so that the pressure sensor detects pressure between the mobile phone main body and the cover.

In a case that the mobile phone is a foldable type and the like which is openable/closable, based on pressure applied between the mobile phone main body and the cover, pressure applied to the mobile phone can be detected.

(2) The mobile phone can further have an open/close sensor, and based on the detected pressure and the detected open/close state, the vibration unit can control vibration of the vibrator.

A usage status is estimated by the open/close state of the cover, and vibration control in compliance with this usage state can be conducted. For example, when the cover is open it is highly possible that the user is in fact using the mobile phone, therefore a vibration magnitude of the vibrator is controlled to a predetermined value (for example, minimum value of vibration intensity).

(3) The mobile phone main body can have a key, with which the pressure sensor can be integrally composed.

Integration of the pressure sensor and the key enables effective utilization of an operation surface of the mobile phone.

(4) The vibration control unit can control vibration of the vibrator at the time of call/mail arrival to increase as the detected pressure decreases.

When pressure is small the mobile phone is not in close contact with the body of the user, and it is possible that the vibration transfer from the mobile phone to the body of the user is not adequately conducted. To solve this problem, vibration of the vibrator is increased as pressure decreases to transmit vibration more surly.

(5) The vibration control unit can control vibration of the vibrator at the time of call/mail arrival to increase in stages as the detected pressure decreases.

Vibration can be monotonely decreased against pressure, while decrease in stages is possible.

(6) The vibration control unit can control vibration of the vibrator in compliance with a representative value of the detected pressure.

It is possible that the mobile phone moves in the breast pocket and the like to cause the pressure sensor to detect pressure. Since such pressure applied for short time may not reflect a degree of contact between the mobile phone and the body of the user, vibration is controlled according to the representative value of detected pressure.

As a representative value, for example, a minimum value or a mean value during a prescribed time can be used.

B. A control method of the mobile phone related to the present invention includes steps in which: the incoming call/mail to the mobile phone is detected; pressure to the mobile phone is detected; in compliance with detected pressure vibration of the vibrator is controlled.

Pressure applied to the mobile phone is detected at the time of call/mail arrival, and in compliance therewith vibration of the mobile phone is controlled. As a result, vibration is controlled in compliance with the degree of contact between the mobile phone and the body of the user, so that notification of an incoming call/mail by vibration can be conducted more surely.

### BRIEF DESCRIPTION OF THE DRAWINGS

FIG. 1 is a block diagram showing a structure of a mobile phone related to a first embodiment of the present invention.

FIG. 2 is a perspective view showing an open state of the mobile phone related to the first embodiment.

FIG. 3 is a perspective view showing a closed state of the mobile phone related to the first embodiment.

FIG. 4 is a graph showing a basic concept for controlling vibration of a vibrator in the first embodiment.

FIG. 5 is a graph showing an example of controlling vibration of the vibrator in the first embodiment.

FIG. 6 is a graph showing another example of controlling vibration of the vibrator in the first embodiment.

FIG. 7 is a graph showing still another example of controlling vibration of the vibrator in the first embodiment.

FIG. 8 is a flowchart showing an example of a vibration control program in the first embodiment.

FIG. 9 is a perspective view showing an appearance of a mobile phone related to a second embodiment of the present invention.

FIG. 10 is an explanatory drawing showing an example of a case in which a pressure sensor is mounted inside a key in the second embodiment.

FIG. 11 is a flowchart showing an example of a vibration control program in the second embodiment.

### DESCRIPTION OF THE EMBODIMENTS

(First Embodiment)

Hereinafter, a mobile phone according to a first embodiment of the present invention will be described with reference to the attached drawings.

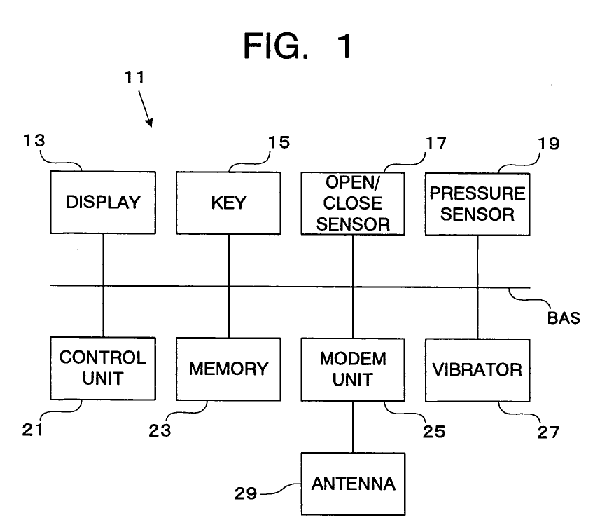

FIG. 1 is a block diagram showing a functional structure of the mobile phone 11 according to this embodiment.

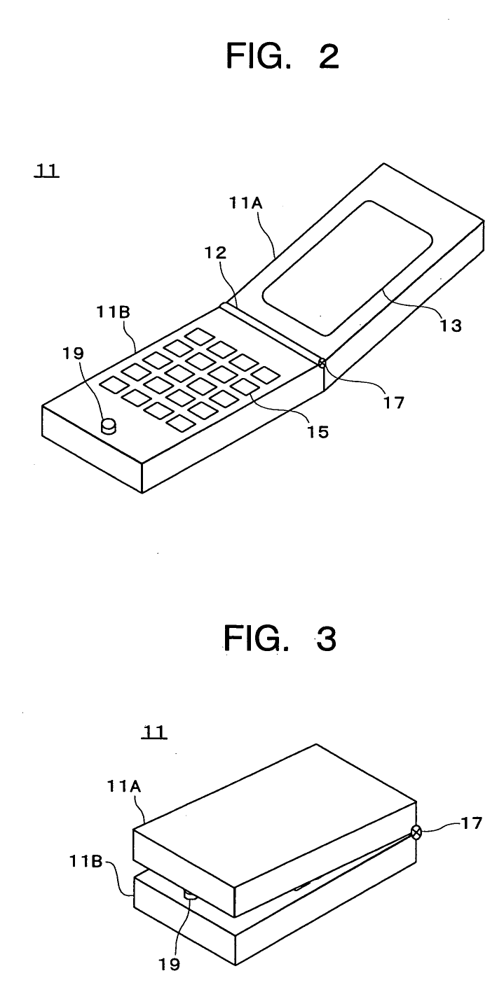

As shown in FIG. 2 and FIG. 3, the mobile phone 11 is so-called foldable type, constituted with a cover (first body part) 11A and a mobile phone main body (second body part) 11B, coupled via a hinge (coupling member) 12, so as to be pivotal (openable and closable).

The mobile phone 11 has, as shown in FIG. 1, a display 13, a key 15, an open/close sensor (open/close detecting unit) 17, a pressure sensor (pressure detecting unit) 19, a control unit 21, a memory 23, a modem unit 25, and a vibrator 27.

The display 13 is, for example, a liquid crystal display, attached to an inner surface side of the cover 11A. The display 13 can display, for example, an outgoing call number, a mail address, an incoming call screen, a mail screen, a moving image, and so forth.

The key 15 is a generic term, which includes plural keys such as number and letter keys as well as keys for various operation and various control (mode selection and the like), and is attached according to a required arrangement on an inner surface side of the mobile phone main body 11B. Various output signals based on the operation of the key 15 are inputted mainly into a control unit 21.

The open/close sensor 17 is mounted to the hinge (pivot portion) 12 and the like which couples the cover 11A and the mobile phone main body 11B so as to be pivotal, and can be constituted with a variable resistor, a contact terminal or the like. The open/close sensor 17 detects, by change in a resistance value of the variable resistor or by presence/absence of contact between corresponding terminals, an open/close state of the cover 11A and the mobile phone main body 11B. Additionally, the sensor 17 outputs to the control unit 21 an open signal indicating the open state and a close signal indicating the closed state of the cover 11A and the mobile phone main body 11B.

The pressure sensor 19 is mounted, for example, at the belowest (see FIG. 2) of the inner surface side (inner side) of the mobile phone main body 11B. In a state that the cover 11A closes to contact the mobile phone main body 11B (see FIG. 3), the pressure sensor 19 detects pressure (pressing force) which the mobile phone main body 11B receives from the cover 11A which moves toward closing direction. Incidentally, the pressure sensor 19 can be mounted at an appropriate position instead of the position shown in FIG. 2.

The pressure sensor 19 outputs to the control unit 21 a pressure signal which corresponds to pressure received from the cover 11A. For example, the pressure sensor 19 outputs to the control unit 21 a pressure signal proportional to pressure at the time of call arrival.

The pressure sensor 19 can constantly output a pressure signal which corresponds to pressure fluctuation, or output a pressure signal according to an instruction from the control unit 21.

The pressure sensor 19 includes, as shown in FIG. 2, a projection member which projects from an inner surface of the mobile phone main body 11B to a predetermined height, and detects pressure which is applied between the cover 11A and the pressure sensor 19. It is possible to keep the key 15 from receiving pressure, by assuring the projection member a projection of specific amount or more, when the cover 11A closes (when the pressure sensor 19 receives pressure).

Incidentally, on the inner surface side of the cover 11A a pressing member can be provided at a position corresponding to the pressure sensor 19 so as to improve transmissibility of pressure.

For the pressure sensor 19, pressure detecting measures such as strengage (load cell), pressure conductive sheet (rubber), pressure sensitive polymer, diaphragm (thin film pressure sensor, diffusion semiconductor pressure sensor), piezo resistive element and so forth can be used.

The control unit 21 is, for example, a CPU (Central Processing Unit) which controls the memory 23 (save and erase of data (call, mail, image, musical sound and so forth)), the modem unit 25, the vibrator 27, a timer function and the like.

When the control unit 21 recognizes an incoming call/mail via the modem unit 25, the control unit 21 outputs musical sound and the like from a speaker (not-shown) in a sound mode and controls drive of the vibrator 27 in a vibration mode. This vibration control is conducted based on a status signal (close signal and the like) from the open/close sensor 17 as well as the pressure signal from the pressure sensor 19.

Incidentally, the control unit 21 can set or switch to/from the sound/vibration modes by operation of the key 15 and the like.

As described before, the control unit 21 controls a vibration magnitude of the vibrator 27, corresponding to pressure detected by the pressure sensor 19.

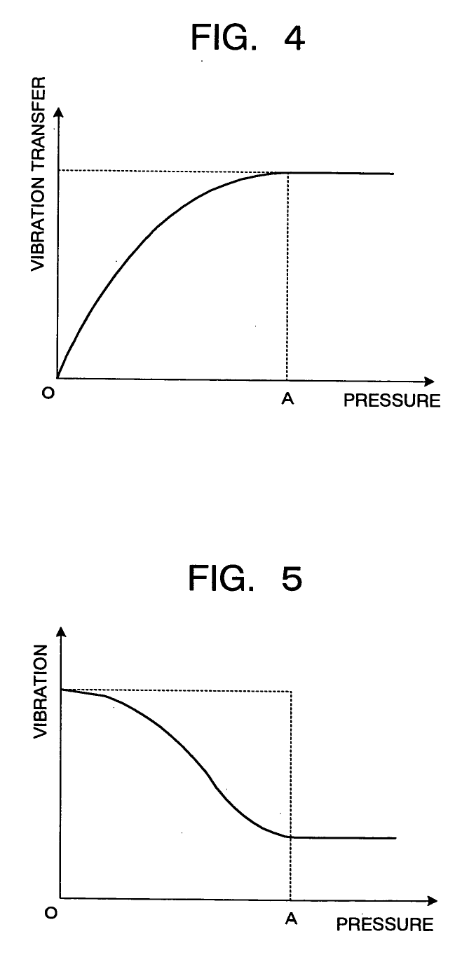

FIG. 4 is a graph showing how pressure between the mobile phone 11 and a body of a user relates to transmissibility of vibration. As shown in FIG. 4, when pressure between the mobile phone 11 and the user is small, vibration from the mobile phone 11 is hard to transmit.

Therefore, the control unit 21 increases vibration when pressure is small and reduces vibration when pressure is large, so as to secure the vibration magnitude transmitted to the body of the user.

When the control unit 21 controls the vibrator 27, control methods (vibration control methods) shown in FIG. 5 to FIG. 7 by way of example can be chosen accordingly, for example, by operation of the key 15.

In a case of the control method shown in FIG. 5, when pressure is small the vibration magnitude reduces gradually, when pressure is in a middle range the vibration magnitude changes relatively rapidly, and when pressure is large the vibration magnitude converges into a predetermined value.

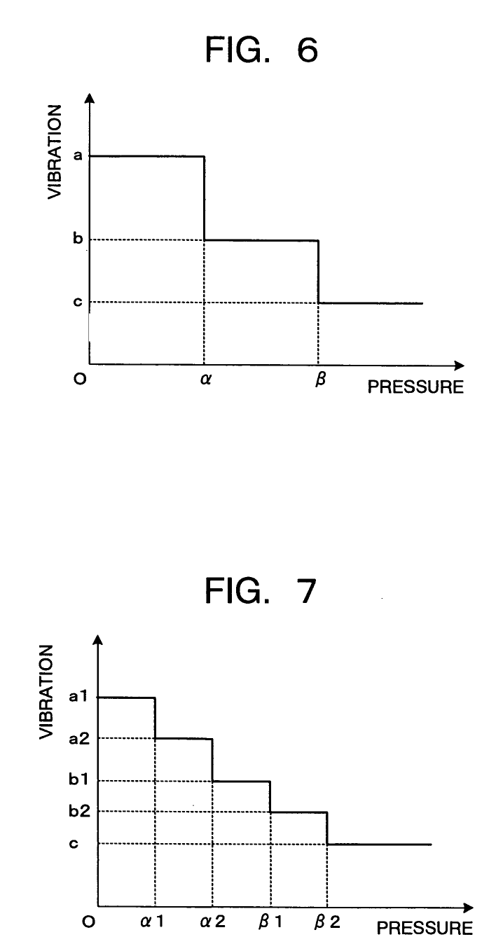

In a case shown in the FIG. 6, pressure ranges are divided into three areas (threshold values) which are 0 (zero)-α, α-β, and β and above, and three-tiered control is conducted. More specifically, the vibration is set, respectively, to a maximum value “a” when pressure is in 0-α range, to a moderate value “b” when pressure is in α-β range, and to a minimum value “c” when pressure is in β and above range.

In a case shown in FIG. 7, ranges of pressure detection are divided into five areas (threshold values) which are 0- α1, α1-α2, α2-β1, β1-β2, and β2 and above, and according to each range of detection the vibration magnitude is divided into five tiers which are a1 (maximum value), a2, b1, b2, and c (minimum value).

Incidentally, the threshold values for pressure may be set as in the examples mentioned above, or any threshold values may be selected. It is a matter of course that a single threshold value can be used.

The memory 23 is, for example, RAM, EPROM, HD (Hard Disk) and the like, which can conduct call recording, mail storage, storage of various histories, and so forth. In the memory 23, there are stored data necessary for control and various programs such as predetermined game program, a program for website start-up (Internet connection), program for vibration control (vibration control method) of the vibrator 27, and the like.

The modem unit 25 conducts modulation of transmission data and demodulation of incoming/received data. The incoming data after demodulation is inputted into the control unit 21.

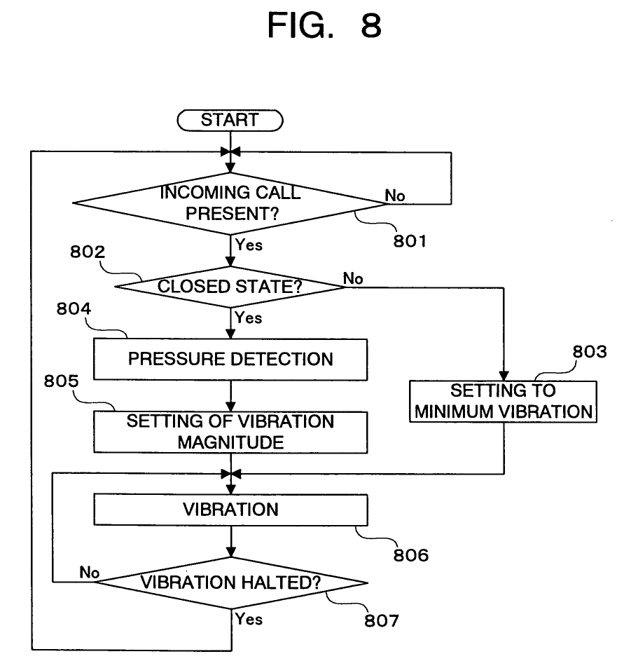

Next, with reference to FIG. 8, an operation of the control unit 21 at the time of call/mail arrival based mainly on the program for vibration control will be described.

First in a step 801, presence/absence of the incoming call/mail is judged. If in the step 801 the incoming call/mail is judged to be present, in a step 802 by import of a status signal of the open/close sensor 17, whether the body (cover 11A) of the mobile phone 11 is in an open state (see FIG. 2) or in a closed state (see FIG. 3) is judged.

When the body is judged to be open, it is highly possible that the mobile phone 11 is in use. In this case in a step 803 vibration of the vibrator 27 is set to minimum, then in a step 806 the vibrator 27 vibrates.

On the other hand, if in the step 802 the mobile phone 11 is judged to be in a closed state, in a step 804 pressure detection is conducted. More specifically, by import of the pressure signal from the pressure sensor 19, pressure applied to the mobile phone main body 11B by the cover 11A (pressure applied to the body of the mobile phone 11) is detected.

Then in a step 805, in compliance with the detected pressure value, the vibration magnitude of the vibrator 27 is set. The vibration magnitude can be set by any one of the control methods shown in FIG. 5 to FIG. 7. Then in the step 806 the vibrator 27 vibrates at the set vibration magnitude.

In a step 807 it is judged whether or not an instruction for halting the vibrator 27 is inputted by a predetermined key operation and the like. For example, when the user presses a talk key the vibration is halted and the call starts.

If the instruction for halting vibration is not inputted, the step 806 is repeated and vibration continues. On the other hand, if the instruction for halting vibration is inputted, vibration is halted and the call/mail is waited in the step 801.

In this embodiment, at the time of call/mail arrival the control unit 21 imports the open signal from the open/close sensor 17 and the pressure signal from the pressure sensor 19. Consequently, pressure applied by the cover 11A to the mobile phone main body 11B is recognized.

As a result, even when the mobile phone 11 is in a breast pocket and the like of the user, a degree of contact is judged, and if this degree of contact is low the vibration magnitude of the vibrator 27 increases. Therefore, when the mobile phone 11 is in the breast pocket and the like of the user, it is avoided that vibration of the mobile phone 11 does not transmit to the user who then fail to notice the incoming call/mail.

Additionally, when the mobile phone 11 closely contacts the body of the user, vibration of the vibrator 27 is reduced. As a result, consumption of power supply is saved to elongate usable time, therefore efficient especially in a case of frequent arrival of the call/mail.

(Second Embodiment)

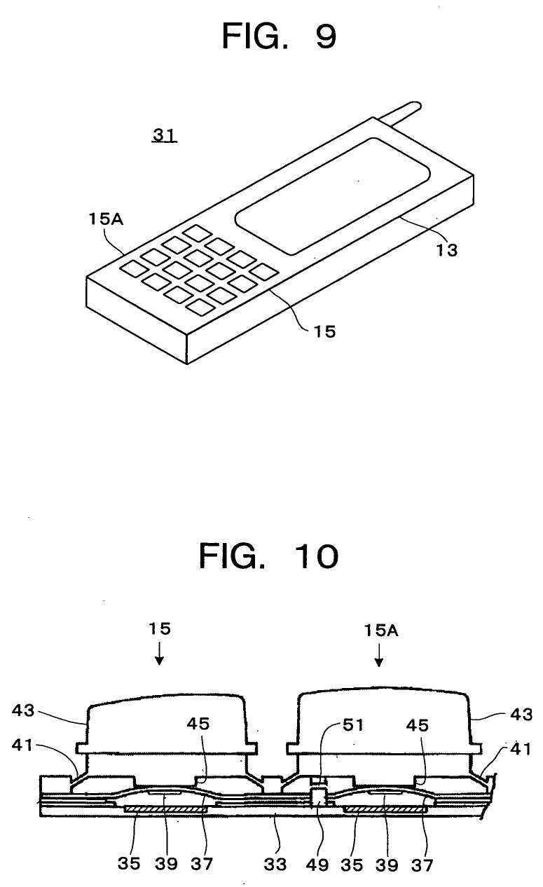

Next, with reference to FIG. 9 to FIG. 11, a mobile phone according to a second embodiment of the present invention will be described. FIG. 9 is a perspective view showing an appearance of the mobile phone according to this embodiment.

Since a mobile phone 31 according to this embodiment is a non-foldable type (not foldable type) mobile phone, the open/close sensor 17 is unnecessary. The other basic structure of the mobile phone 31 is the same as those in the block diagram shown in FIG. 1, so that detailed descriptions will be restrained.

On a front surface side of the mobile phone 31, a display 13 and a key. 15 are attached. Plural keys are named generically as the key 15. On a body base plate (base plate 33) in an interior of a predetermined key 15A (such as “*” key which is positioned for example at the belowest side of the body) among the key 15, a pressure sensor 49 is mounted (see FIG. 10).

The key 15A can be structured, for example, as shown in FIG. 10, by mounting at a predetermined position on the base plate 33 a fixed contact 35, and by mounting thereover a click dome 37 which is bendable upward/downward.

On a rear surface of the click dome 37, a movable electrode 39 which faces the fixed contact 35 is provided. On a surrounding are of a dome part of the click dome 37, via a supporting member 41 which has flexibility, a key top 43 is placed, and at the bottom thereof is formed a pressing portion 45 capable of pressing the dome part.

When the key top 43 is pressed down, pressed by the pressing portion 45 of the key top 43 the dome part of the click dome 37 is bent downward, so that the movable electrode 39 on the rear surface of the dome part contacts the fixed contact 35. This contact enables current carrying, so that a signal corresponding uniquely to the key 15A is outputted to the control unit 21.

When a finger leaves the key top 43, by a reaction force of the supporting member 41 of the key top 43 as well as a reaction force of the dome part of the click dome 37, the key top 43 moves upward to return to an original position, with the movable electrode 39 also leaving the fixed contact 35 to return to an original position.

To a pressure sensor 49, the composition described in the first embodiment can be applied. In FIG. 10, the pressure sensor 49 is mounted on the base plate 33 around the dome part of the click dome 37. At the corresponding position of the click dome 37, an opening is formed, through which the pressure sensor 49 projects upward.

Incidentally, the pressure sensor 49 can be mounted at a position on the base plate 33 corresponding to a center of the dome part of the click dome 37. In that case, it is preferable that the opening for the pressure sensor 49 is formed at the center of the dome part.

Near the pressing portion 45 of the key top 43, at the position facing the pressure sensor 49, a pressing projection (pressing portion) 51 is provided in consideration of transmissibility of pressure applied to the key top 43. Incidentally, though in FIG. 10 there exists a space between the pressure sensor 49 and the pressing projection 51, this space is dispensable.

In this embodiment, both pressure application and key inputting are detectable.

For example, elastic material is used for the pressing projection 51, so that in a state of the pressure sensor 49 contacting the pressing projection 51 an interval between the movable electrode 39 and the fixed contact 35 is changeable. Consequently, while the pressure sensor 49 detects pressure applied by the pressing projection 51, the ON/OFF between the movable electrode 39 and the fixed contact 35 can be conducted.

Naturally, without usage of the movable electrode 39 or the fixed contact 35, the pressure sensor 49 alone can also detects both pressure application and key inputting. When pressure detected by the pressure sensor 49 is equal or above a predetermined value, it can be judged that key inputting is being conducted. Consequently, by a simple composition both pressure application and key inputting can be detected.

With the mobile phone 31 being put in the breast pocket and the like, pressure is applied to the key top 43 of the key 15A, then via the key top 43 and the pressing projection 51 pressure is applied to the pressure sensor 49, so that the pressure sensor 49 can output to the control unit 21 a pressure signal corresponding to a pressure value.

The control unit 21 can be configured to validate a result of pressure detection in the case that inputting to key 15A or pressure detection continues for and over a predetermined period at the time of call/mail arrival.

When the mobile phone 31 moves in the breast pocket of the user, incidental pressure may be applied. Also, since the pressure sensor 49 is composed integrally with the key 15A, it is possible that the user press the key 15 for purpose as a key so that temporal pressure is applied to the pressure sensor 49.

The above-described incidental or temporal pressure application does not reflect the degree of contact between the mobile phone 31 and the body of the user. Therefore, pressure continued for a certain period can be used, as representative detected pressure which represents the degree of contact between the mobile phone 31 and the body of the user, for control of the vibrator 27.

More specifically, minimum pressure detected during a predetermined period can be used as representative detected pressure. Also, a mean value of pressure detected during a predetermined period can be used as representative detected pressure. As just described, despite momentaneous pressure at measurement time, representative detected pressure during a predetermined period since measurement time is obtained, so that by representative detected pressure the vibration magnitude of the vibrator 27 is controlled.

Incidentally, when the control unit 21 controls based on the pressure signal from the pressure sensor 49 vibration of the vibrator 27, as the control method thereof various control methods described in the first embodiment can be adopted.

In a case of this embodiment, in the memory 23 a vibration control program (vibration control method) for the non-foldable type mobile phone 31 is stored.

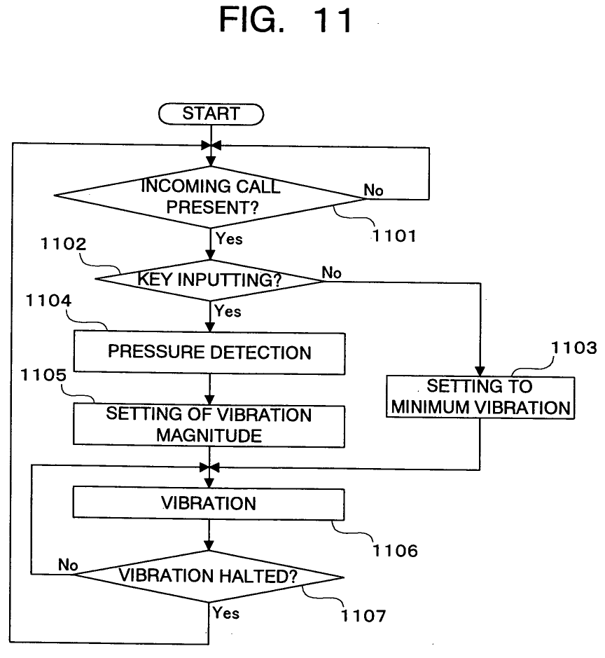

Next, with reference to FIG. 11, an operation of the control unit at the time of call/mail arrival based mainly on the vibration control program for the mobile phone 31 will be described

First in a step 1101, presence/absence of an incoming call/mail is judged. If in the step 1101 the incoming call/mail is judged to be present, in a step 1102 whether key inputting of the key 15 is in progress or not is checked. Presence/absence of key inputting can be conducted based on whether the key 15 is ON or not. More specifically, according to whether ON/OFF of the key 15 is switched or not during a predetermined period, presence/absence of key inputting is judged. More preferably, presence/absence of key inputting can be judged based on whether the different key 15 is continually inputted or not. It is because at the time of key inputting the same key is rarely in pressed condition.

If key inputting is judged present, in a step 1103 vibration of the vibrator 27 is set to minimum, then in a step 1106 the vibrator 27 is vibrated.

On the other hand, if in the step 1102 key inputting is judged to be absent, in a step 1104 pressure detection is conducted. More specifically, by import of the pressure signal from the pressure sensor 49, pressure applied to the mobile phone 31 is detected.

Then in a step 1105 in compliance with the detected pressure value, the vibration magnitude of the vibrator 27 is set. The vibration magnitude can be set based on any one of the control methods shown in FIG. 5 to FIG. 7. Thereafter, in the step 1106 the vibrator is vibrated at a predetermined magnitude.

Then, in step 1107 whether or not vibration of the vibrator 27 is halted by predetermined key operation and the like is judged. If the vibration is not halted the step 1106 is repeated, and if vibration is halted the step 1101 is repeated.

In this embodiment, at the time of call/mail arrival the control unit 21 checks key inputting, then imports the pressure signal from the pressure sensor 49, so that pressure applied to a body of the mobile phone 31 is recognized.

As a result, even when the mobile phone 31 is in the breast pocket and the like of the user, the degree of contact to the user is judged, and if this degree is low the magnitude of the vibrator 27 is increased. Therefore, when the mobile phone 31 is in the breast pocket and the like of the user, it is avoided that vibration of the mobile phone 31 does not transmit to the user who then fail to notice the incoming call/mail.

Incidentally, when the mobile phone 31 closely contacts the body of the user, the magnitude of the vibrator 27 is reduced. AS a result, power consumption of power supply is saved to elongate usable time, therefore effective especially in a case of frequent arrival of the call/mail.

(Other Embodiments)

The present invention is not limited to the above-described embodiment, and expansion and change thereof may be made. The expanded and changed embodiments are also included in the technical range of the present invention.

For example, though in the aforementioned embodiments a case of the pressure sensor 49 being mounted on the predetermined key 15A is described, the pressure sensor 49 can be mounted on plural keys or all keys at a predetermined position which easily receives pressure.

1. A mobile phone comprising:
a mobile phone main body;
a vibrator vibrating said mobile phone main body;
a pressure sensor detecting pressure applied to said mobile phone main body; and
a vibration control unit controlling vibration of said vibrator in compliance with pressure detected by said pressure sensor.

2. The mobile phone as set forth in claim 1,
further comprising a cover openable/closable to said mobile phone main body, and
wherein said pressure sensor detects pressure applied between said mobile phone main body and said cover.

3. The mobile phone as set forth in claim 1,
further comprising an open/close sensor detecting an open/close state of said cover, and
wherein, based on the detected pressure and the detected open/close state, said vibration control unit controls vibration of said vibrator.

4. The mobile phone as set forth in claim 3, wherein when the detected open/close state indicates the open state of said cover, said vibration control unit controls a vibration magnitude of said vibrator to a predetermined value.

5. The mobile phone as set forth in claim 1,
wherein said mobile phone main body has a key to input data with, and
said pressure sensor is composed integrally with the key.

6. The mobile phone as set forth in claim 1, wherein said vibration control unit controls vibration of said vibrator at the time of call/mail arrival to increase as the detected pressure decreases.

7. The mobile phone as set forth in claim 6, wherein said vibration control unit controls vibration of said vibrator at the time of call/mail arrival to increase in stages as the detected pressure decreases.

8. The mobile phone as set forth in claim 1, wherein said vibration control unit controls vibration of said vibrator in compliance with a representative value of the detected pressure.

9. The mobile phone as set forth in claim 8, wherein the representative value of the pressure is a minimum value of pressure detected during a prescribed time.

10. The mobile phone as set forth in claim 8, wherein the representative value of the pressure is a mean value of pressure detected during a prescribed time.

11. A vibration control method of a mobile phone, comprising:
detecting an incoming call/mail to the mobile phone;
detecting pressure to the mobile phone; and
controlling vibration of a vibrator in compliance with a magnitude of the detected pressure.

12. The vibration control method of the mobile phone as set forth in claim 11,
wherein the mobile phone has a mobile phone main body, and a cover openable/closable to the mobile phone main body, and, in detecting pressure, pressure applied between the mobile phone main body and the cover is detected.

13. The vibration control method of the mobile phone as set forth in claim 11,
wherein the mobile phone have a mobile phone main body and a cover openable/closable to the mobile phone main body,
further comprising detecting open/close state of the cover, and
wherein, in controlling vibration, based on the detected pressure and the detected open/close state, vibration of the vibrator is controlled.

14. The vibration control method of the mobile phone as set forth in claim 13, wherein when the detected open/close state indicates the open sate of the cover, in controlling vibration, the vibration magnitude of the vibrator is controlled to a predetermined value.

15. The vibration control method of the mobile phone as set forth in claim 11, wherein, in controlling vibration, vibration of the vibrator is controlled to increase as the detected pressure decreases.

16. The vibration control method of the mobile phone as set forth in claim 15, wherein, in controlling vibration, vibration of the vibrator is controlled to increase in stages as the detected pressure decreases.

17. The vibration control method of the mobile phone as set forth in claim 11, wherein, in controlling vibration, vibration of the vibrator is controlled in compliance with a representative value of the detected pressure.
